(19) United States
(12) Patent Application Publication
(10) Pub. No.: US 2006/0076778 A1
(43) Pub. Date: Apr. 13, 2006

(54) Extension conduit assembly for a fire sprinkler drain outlet

(76) Inventors: William W. Parnell, Martinsville, IN (US); Gerry G. Euliss, Indianapolis, IN (US)

Correspondence Address: Paul J. Maginot;Suite 3000, 111 Monument Circle, Indianapolis, IN, 46204-5115, US

(21) Appl. No.: 11/243,692

(22) Filed: Oct. 5, 2005

Related U.S. Application Data
(60) Provisional application No. 60/616,684, filed on Oct. 7, 2004.

(51) Int. Cl. F16L 25/00

(52) U.S. Cl. 285/420

(57) ABSTRACT

A conduit assembly adapted to be used with a fire sprinkler drain outlet is disclosed. The conduit assembly includes a conduit segment including (i) an intake end portion having a proximal opening configured to receive the fire sprinkler drain outlet therein, and (ii) a discharge end portion defining a terminal end of the conduit segment and having a first distal opening defined in a first lateral side of the conduit segment and a second distal opening defined in a second lateral side of the conduit segment, each of the first distal opening and the second distal opening being spaced apart from the terminal end of the conduit segment. The conduit assembly further includes a coupling mechanism supported on the intake end portion of the conduit segment, the coupling mechanism including (i) a strap configured to extend around the fire sprinkler drain outlet, and (ii) a ratchet tensioning device coupled to the strap and operable to tighten the strap around the fire sprinkler drain outlet when the fire sprinkler drain outlet is positioned within the proximal opening of the intake end portion of the conduit segment. Moreover, the conduit assembly includes a stabilizing component attached to the discharge end portion of the conduit assembly, the stabilizing component including (i) a first elongate portion extending from the first lateral side of the conduit segment, and (ii) a second elongate portion extending from the second lateral side of the conduit segment.

This application claims the benefit of U.S. Provisional Application Ser. No. 60/616,684, filed Oct. 7, 2004. The disclosure of the above-identified provisional patent application is hereby totally incorporated by reference in its entirety.

### TECHNICAL FIELD OF THE INVENTION

The present invention relates generally to fire sprinkler systems, and more particularly to an extension conduit assembly for a drain outlet of a fire sprinkler system that is configured to control and direct water being discharged from the fire sprinkler system drain outlet to a desired remote location.

### BACKGROUND OF THE INVENTION

From time to time it is necessary to drain water from a fire sprinkler system 5 located in a building 10 such as an office building. (See e.g. FIGS. 1 and 2.) The sprinkler system 5 includes a drain outlet 12 which is typically located on a vertically oriented outside wall of the building 10 as shown in FIG. 2. Other examples of such drain outlets 12′ and 12″ on outside building walls are shown in FIGS. 3 and 4.

Heretofore, the process of draining water from the fire sprinkler system 5 tended to caused damage to the environment surrounding the drain outlet 12. For example, if the drain outlet 12 is positioned over a landscaped area in which mulch is spread (see FIG. 2), the water exiting the drain outlet 12 of the fire sprinkler system 5 would tend to cause the mulch to be displaced thereby causing unsightly mulch patches 13 to be created on nearby sidewalks and parking lots. As another example, if the drain outlet 12′ is positioned over a grassy area (see FIG. 3), repeated fire sprinkler system draining iterations over time using the drain outlet 12′ tended to cause grass to die thereby causing unsightly dead patches 15 in the grassy area. In another example, if the drain outlet 12″ is positioned near a sidewalk 17 of a building 10″ (see FIG. 4), water exiting the drain outlet 12″ may overflow the sidewalk 17 thereby creating a water pool that inhibits pedestrian egress and ingress to the building. If this occurs during winter months, such pooling of water over the sidewalk 17 may be hazardous due to freezing of such pooled water. In any event, after the water evaporates from the sidewalk 17, the pooled water may leave a stain on the sidewalk 17 since the water exiting the drain outlet 12″ typically contains contaminants such as rust. And further since such water contains contaminants therein, a foul smell may be created near the building 10″ by the pooled water while the water is evaporating.

What is needed is an apparatus for controlling and directing water being discharged from a fire sprinkler system drain outlet to a desired remote location. Such an apparatus should be readily attachable to and detachable from any fire sprinkler system drain outlet without the need for an expensive adaptor. Such apparatus should be configured to be easily deployed, and conveniently stored when not in use.

### OBJECTS OF THE INVENTION

In order to address these and other difficulties experienced in the prior art, the present invention contemplates an extension conduit assembly for a fire sprinkler drain outlet as shown and described herein.

One object of the present invention to provide an extension conduit assembly for controlling and directing the flow of water exiting a fire sprinkler system drain outlet.

It is another object of the present invention to provide an extension conduit assembly that is readily and securely attachable to and detachable from a fire sprinkler system drain outlet.

It is yet another object of the present invention to provide an extension conduit assembly for a fire sprinkler drain outlet that can be easily deployed for use, and readily gathered and stowed after use.

It is moreover an object of the present invention to provide an extension conduit assembly for a fire sprinkler drain outlet that is configured for convenient and compact storage when not in use.

It is still another object of this present invention to provide an extension conduit assembly for a fire sprinkler drain outlet that includes a discharge end portion that does not significantly move around when the assembly is connected to the drain outlet and water is being conveyed therethrough at a relatively high flow rate.

The above described features and advantages, as well as others, will become more readily apparent to those of ordinary skill in the art by reference to the following detailed description and accompanying drawings.

### BRIEF DESCRIPTION OF THE DRAWINGS

FIG. 1 is a perspective view of a fire sprinkler system located within a building;

FIG. 2 is a perspective view of the building of FIG. 1 showing a drain outlet of the fire sprinkler system of FIG. 1;

FIG. 3 is a perspective view of another building showing another drain outlet of another fire sprinkler system;

FIG. 4 is a perspective view of yet another building showing yet another drain outlet of yet another fire sprinkler system;

FIG. 5 is a perspective view of an extension conduit assembly for a fire sprinkler drain outlet that incorporates features of the present invention therein, and further showing a storage belt for use with the assembly;

FIG. 6 is a perspective view of an intake end portion of the assembly of FIG. 5;

FIG. 7 is another perspective view of the intake end portion of the assembly of FIG. 5;

FIG. 8 is a perspective view of a discharge end portion of the assembly of FIG. 5;

FIG. 9 is a perspective view of the assembly of FIG. 5 shown in its extended position and coupled a drain outlet of a fire sprinkler system;

FIG. 10 is a perspective view of the assembly of FIG. 5 being held its rolled configuration by a storage belt that is wrapped around the assembly;

FIG. 11 is a perspective view of an intake end portion of another embodiment of an extension conduit assembly for a fire sprinkler drain outlet that incorporates features of the present invention therein; and

FIG. 12 is a perspective view of the intake end portion of the assembly of FIG. 11 being coupled to a drain outlet of a fire sprinkler system.

### DETAILED DESCRIPTION OF THE DRAWINGS

While the invention is susceptible to various modifications and alternative forms, specific embodiments thereof have been shown and described by way of example in the drawings and associated text. It should be understood, however, that there is no intent to limit the invention to the particular forms disclosed, but on the contrary, the intention is to cover all modifications, equivalents, and alternatives falling within the spirit of the invention.

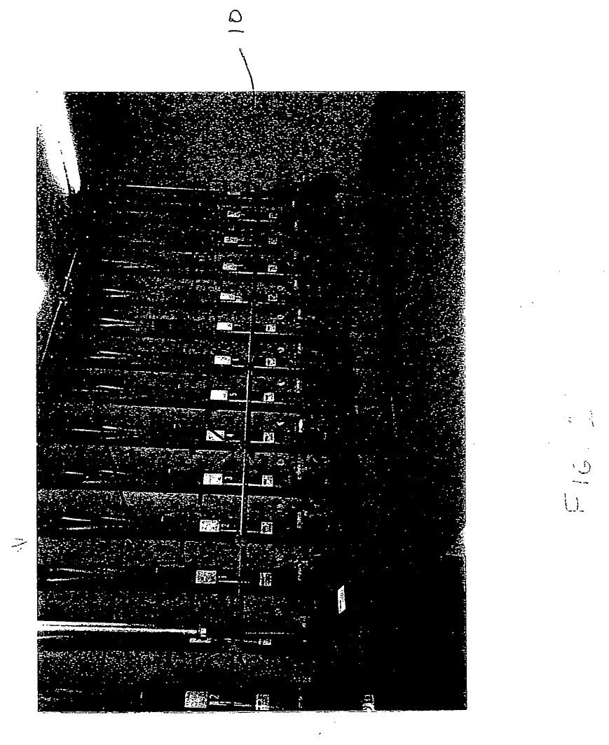

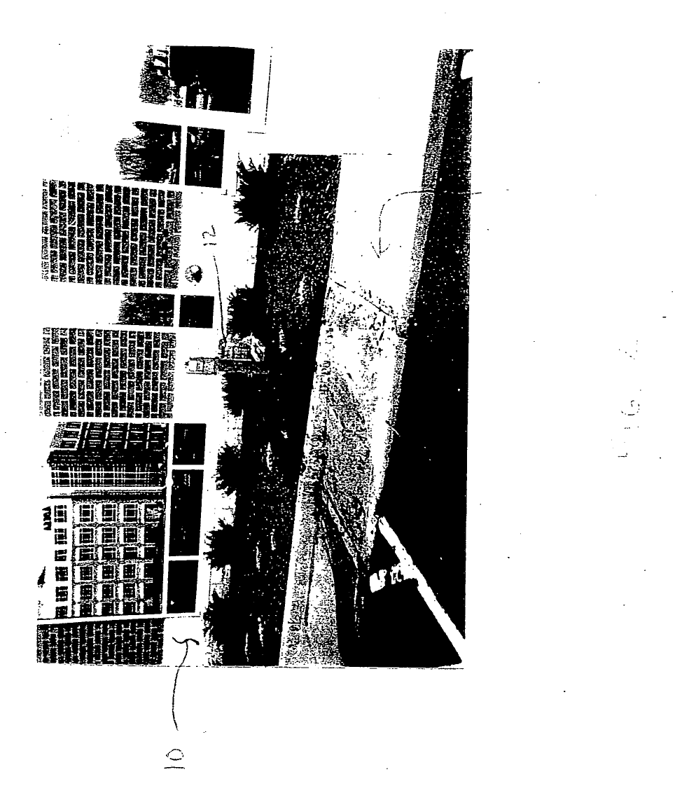

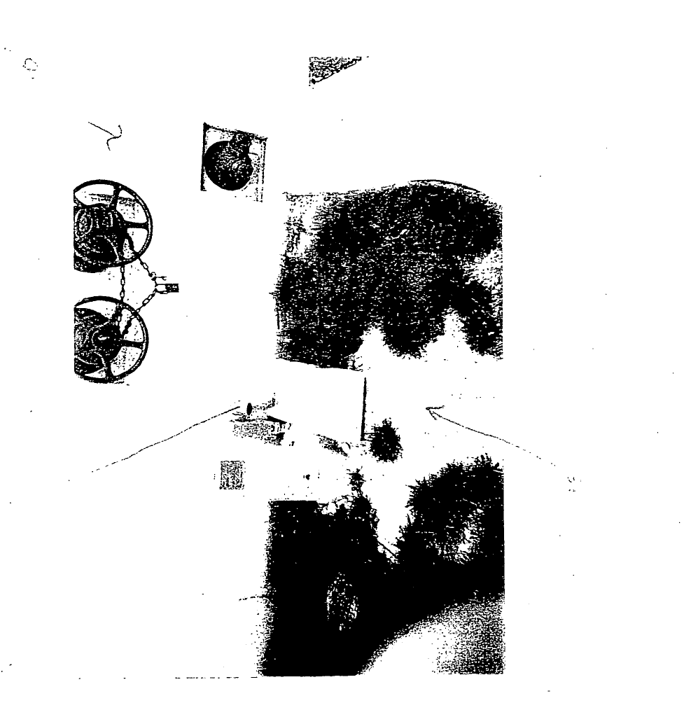

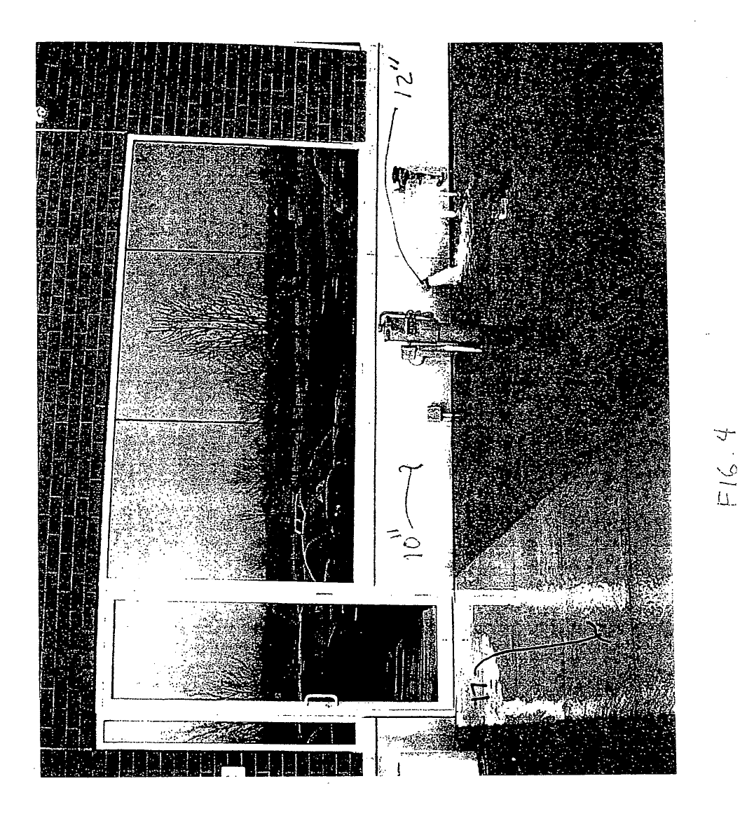

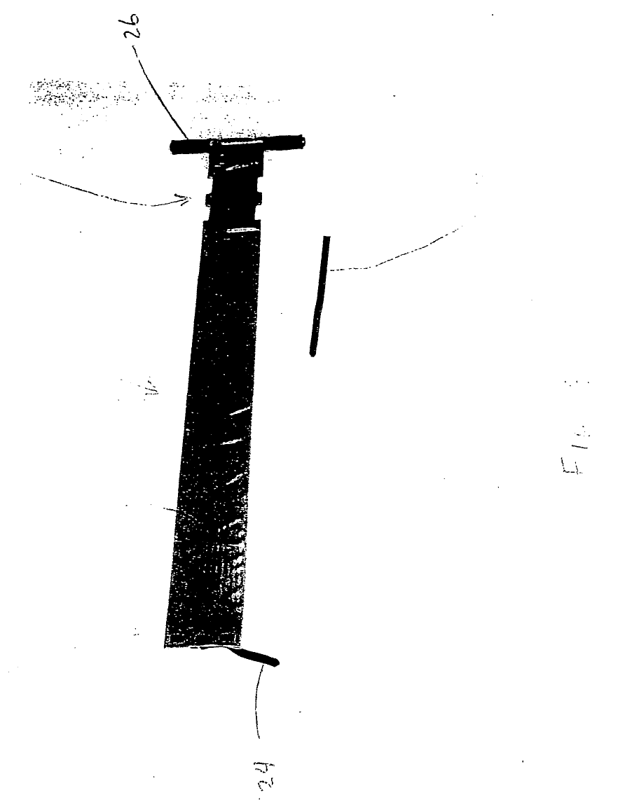

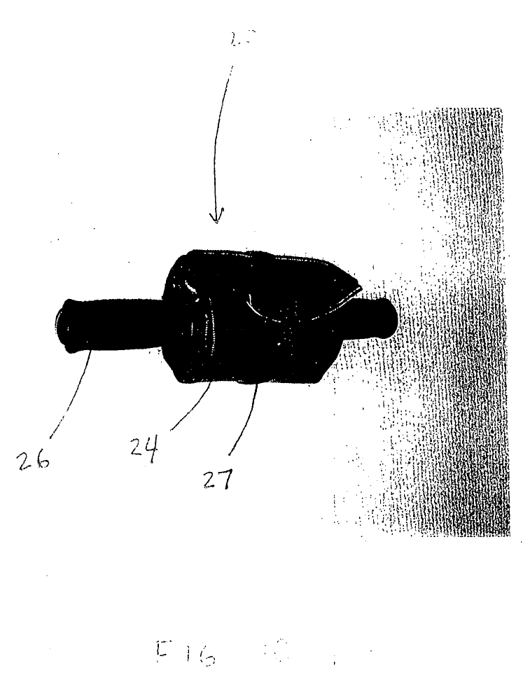

Referring now to FIG. 5, there is shown a preferred embodiment of an extension conduit assembly 20 for a drain outlet of a fire sprinkler system such as drain outlet 12 of the fire sprinkler system 5 shown in FIGS. 1 and 2. The assembly 20 includes a conduit segment 22, a fastening belt 24, and a rolling/stabilizing component 26. A storage belt 27 is also shown in FIG. 5 and is used to retain the conduit segment 22 after it is rolled into a rolled configuration as shown in FIG. 10. The conduit segment 22 has an intake end portion 28 and a discharge end portion 30. The conduit segment 22 possesses a construction substantially similar to a water conveying tubular portion of a fire hose assembly that is commonly used by firemen when fighting fires. The conduit segment 22 may possess any desired length.

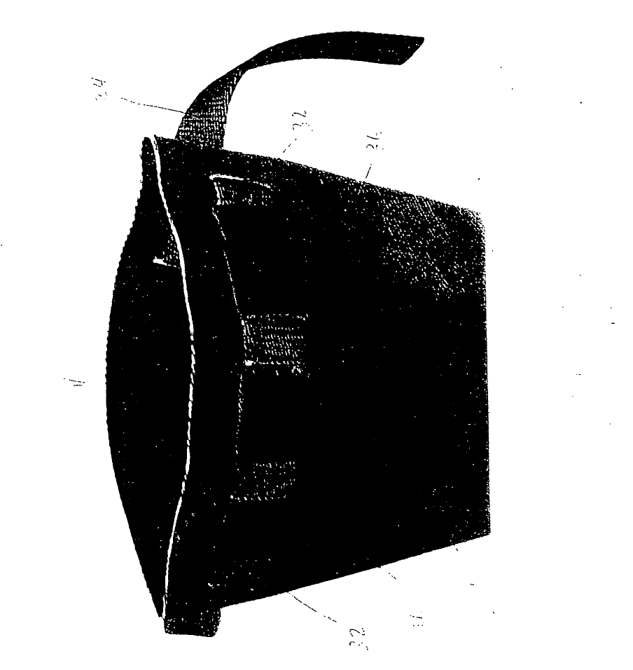

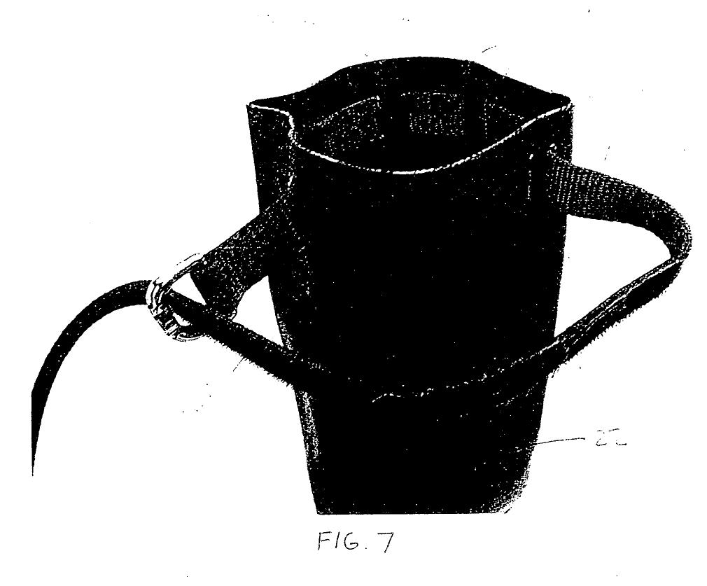

The intake end portion 28 of the assembly 20 is shown in more detail in FIGS. 6 and 7. The intake end portion 28 has a plurality of slits 32 defined therein. The slits 32 are spaced apart from each other around the circumference of the intake end portion 28. The slits are configured to allow the fastening belt 24 to be threaded therethrough as shown in FIGS. 6 and 7. The fastening belt 24 includes a plurality of hooks 34 that engage a plurality of loops 36 that are secured to the outer surface of the intake end portion 28. The plurality of hooks 34 and the plurality of loops 36 are constructed and operate in a manner similar to the ubiquitous VELCRO fastener device. Alternatively, both the plurality of hooks 34 and plurality of loops 36 may be disposed on the fastening belt 24. In any event, the fastening belt 24 is configured to secure the intake end portion 28 to the drain outlet 12 so that water exiting the drain outlet 12 will be conveyed through conduit segment 22 to the discharge end portion 30 without any substantial water leakage at the intake end portion/drain outlet interface.

Further, the fastening belt 24 is configured to quickly secure the intake end portion 28 to the drain outlet 12, as well as, quickly decouple the intake end portion 28 from the drain outlet 12. In a preferred embodiment, the fastening belt 24 is twenty-four inches long, but alternatively may be greater than or less than twenty-four inches so long as the belt is long enough to extend around the circumference of the intake end portion 28 and possess enough slack to securely fasten the intake end portion 28 to the drain outlet 12 via the hooks 34 and loops 36. In other embodiments of the present invention, the fastening belt 24 may take the form of a cable tie, wire cable, elastic band, or a hose clamp.

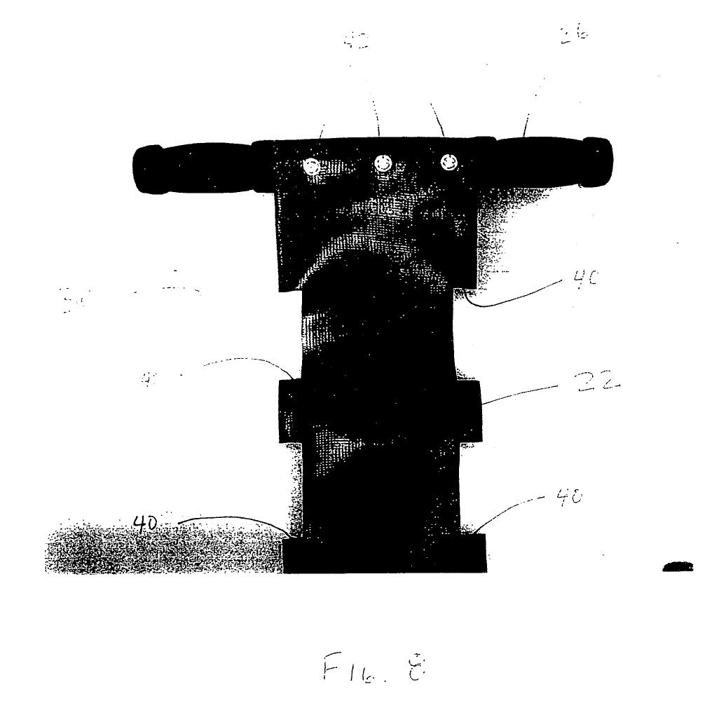

Referring now to FIG. 8, the discharge end portion 30 of the assembly 20 includes a plurality of discharge openings 40. The discharge openings 40 are formed in the lateral sides of the conduit segment 22 as shown in FIG. 8. In the preferred embodiment, there are two discharge openings 40 on each lateral side of the discharge end portion 30. Of course, there may be more or less discharge openings on each lateral side of the discharge end portion 30. Further, in the preferred embodiment, the discharge openings 40 are uniform in size in order to balance the force applied to the discharge end portion 30 by the flow of water passing through the conduit segment 22 during operation of the assembly 20. This feature helps to prevent abrupt movement of the discharge end portion 30 of the assembly 20 during operation thereof. Moreover, the rolling/stabilizing component 26 also helps to prevent abrupt movement of the discharge end portion 30 of the assembly 20 during operation thereof.

The rolling/stabilizing component 26 is secured to the discharge end portion of the assembly 22 with a plurality of fasteners 42 as shown in FIG. 8. While three fasteners 42 are shown being utilized to secure the rolling/stabilizing component 26 to the discharge end portion of the assembly 22 in FIG. 8, any number of fasteners may be used such as two, four, five, or more. The component 26 includes a cylindrical rod that is approximately fifteen inches in length and one inch in diameter. The cylindrical rod is preferably made of a durable material such as metal, wood, or hard plastic. The component 26 further includes a left lateral foam sleeve positioned around a left lateral portion of the cylindrical rod, and a right lateral sleeve positioned around a right lateral portion of the cylindrical rod. The left and right foam sleeves provide a soft feel to a user.

### OPERATION OF THE PRESENT INVENTION

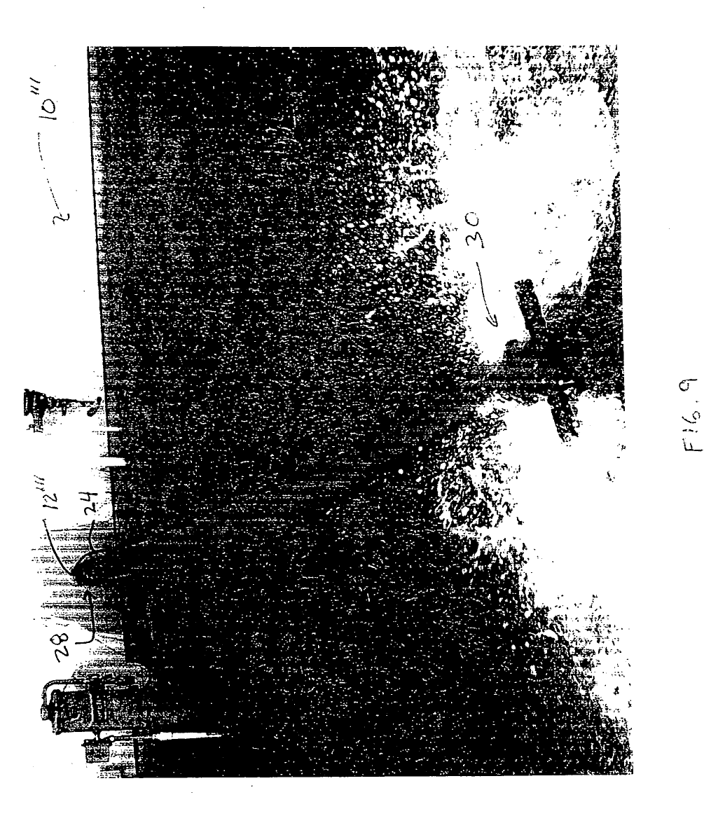

During operation the assembly 20 is located in an extended position as shown in FIG. 9. In such extended position, the intake end portion 28 is coupled to a drain outlet 12″′ of a fire sprinkler system (not shown). The drain outlet 12″′ is mounted on a vertically oriented wall of a building 10″′. The coupling between the intake end portion and the drain outlet is created when a free end of the fastening belt 24 is pulled tightly while the drain outlet 12″′ is positioned within the intake end portion 28, and thereafter the fastening belt is pulled around the intake end portion 28 so that the plurality of hooks 34 engage the plurality of loops 36 in a secure manner.

While the assembly 20 is positioned in its extended position and coupled to the drain outlet 12″′, the fire sprinkler system is then drained so that water exits the drain outlet 12″′ and passes through the conduit segment 22, and then exits out the assembly 20 through the discharge openings 40 defined in the discharge end portion 30 as shown in FIG. 9. The water advances in this manner until the entire fire sprinkler system is drained. Thereafter, the assembly 20 is decoupled from the drain outlet 12″′ by decoupling the plurality of hooks 34 from the plurality of loops 36, and then pulling the intake end portion 28 away from the drain outlet 12″′.

Rolling and storage of the extension conduit assembly after use will now be discussed. In particular, the assembly 20 is manipulated into a rolled configuration as shown in FIG. 10. To this end, a user places the assembly 20 on the ground and then grasps the left and right lateral hand grips. Thereafter, the user rolls the assembly 20 so that the rolling/stabilizing component 26 is rotated about its central axis. This rotation causes the conduit segment 22 to flatten and become rolled around the rolling/stabilizing component 26 until the rolled configuration shown in FIG. 10 is obtained. Thereafter, the storage belt 27 is wrapped around the assembly 20 and secured in place as shown in FIG. 10. To this end, the storage belt 27 also contains a plurality of hooks and a plurality of loops that are constructed and operate in a manner similar to a VELCRO fastener device. In its rolled configuration, the assembly 20 can be easily transported and thereafter conveniently stowed until needed.

It will be appreciated that the above describe embodiments are merely exemplary, and that those of ordinary skill in the art may readily devise their own implementations and variations that incorporate the principles of the present invention and fall within the spirit and scope thereof.

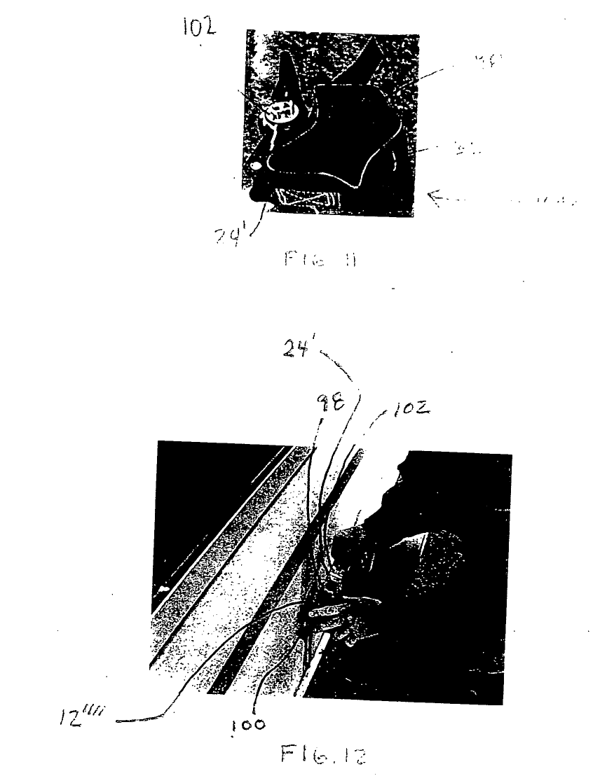

For example, the assembly 20 may be modified to include a ratchet tensioning device for tightening the fastening belt 24 around a drain outlet such as any of drain outlets 12, 12′, 12″, and 12″′. Such an alternative embodiment is depicted in FIGS. 11 and 12. Note that FIG. 11 shows an intake end portion 98 of an extension conduit assembly 100, and FIG. 12 shows the intake end portion 98 of the extension conduit assembly 100 being coupled to a drain outlet 12″″ of a fire sprinkler system (not shown). The assembly 100 possesses the exact same physical construction, and is utilized and operated in the exact same manner, as assembly 20 discussed above with the exception that the fastening belt of the assembly 100 does not include hooks (such as hooks 34) and loops (such as loops 36). Rather, a ratchet tensioning device 102 is coupled to the fastening belt so as to selectively tension the belt around a drain outlet such as drain outlet 24″″ shown in FIG. 12. In this regard, one end of the fastening belt 24′ is secured to a first portion of the ratchet tensioning device 102 while another end of the belt 24′ is wrapped around a windup spindle of the tensioning device 102. An intermediate portion of the belt 24′ is threaded through slits 32′ defined in the intake end portion 28′ of the assembly 20′ in the same manner shown in FIGS. 6-7 and discussed above with regard to the assembly 20. Upon user actuation of the tensioning device 102, a loop formed by the belt 24′ which is threaded through the intake end portion 28′ becomes smaller (i.e. reduces in diameter) thereby tightening the assembly 20′ onto the outer surface of the drain outlet 12″″. This feature allows for a highly secure attachment between the assembly 20′ and the drain outlet 12″″, and is especially useful when high fluid pressures (e.g. 100-105 psi) are experienced at the junction between the assembly 20′ and drain outlet 12″″ as is typically the case during draining water from a fire sprinkler system. The ratchet tensioning device 102 is constructed and operated in a manner similar to any of the ratchet tensioning devices disclosed in any of U.S. Pat. Nos. 4,199,182 (Sunesson); 4,227,286 (Holmberg); 4,542,883 (Rutzki); 5,271,606 (Kamper); and 5,549,429 (Sergent), the disclosures of each of these U.S. patents being hereby totally incorporated by reference in its entirety. Accordingly, the tensioning device 102 may be operated to quickly secure the assembly 20′ to the drain outlet 12″″, as well as quickly release the assembly from the drain outlet.

What is claimed is:

1. A conduit assembly adapted to be used with a fire sprinkler drain outlet, comprising:
a conduit segment including (i) an intake end portion having a proximal opening configured to receive said fire sprinkler drain outlet therein, and (ii) a discharge end portion defining a terminal end of said conduit segment and having a first distal opening defined in a first lateral side of said conduit segment and a second distal opening defined in a second lateral side of said conduit segment, each of said first distal opening and said second distal opening being spaced apart from said terminal end of said conduit segment;
a coupling mechanism supported on said intake end portion of said conduit segment, said coupling mechanism including (i) a strap configured to extend around said fire sprinkler drain outlet, and (ii) a ratchet tensioning device coupled to said strap and operable to tighten said strap around said fire sprinkler drain outlet when said fire sprinkler drain outlet is positioned within said proximal opening of said intake end portion of said conduit segment; and
a stabilizing component attached to said discharge end portion of said conduit assembly, said stabilizing component including (i) a first elongate portion extending from said first lateral side of said conduit segment, and (ii) a second elongate portion extending from said second lateral side of said conduit segment.

2. The conduit assembly of claim 1, wherein:
said intake end portion of said conduit assembly includes a plurality of slits defined therein,
said strap of said coupling mechanism is threaded through said plurality of slits.

3. The conduit assembly of claim 1, wherein:
said discharge end portion of said conduit assembly further has a third distal opening and a fourth distal opening defined therein,
said third distal opening is defined in said first lateral side of said conduit assembly,
said fourth distal opening is defined in said second lateral side of said conduit assembly, and
each of said third distal opening and said fourth distal opening is spaced apart from said terminal end of said conduit segment.

4. The conduit assembly of claim 1, wherein said first distal opening and said second distal opening are configured to be uniform in size.

5. A conduit assembly adapted to be used with a fire sprinkler drain outlet, comprising:
a conduit segment including (i) an intake end portion having a proximal opening configured to receive said fire sprinkler drain outlet therein, and (ii) a discharge end portion having at least one distal opening; and
a coupling mechanism supported on said intake end portion of said conduit segment, said coupling mechanism including (i) a strap configured to extend around said fire sprinkler drain outlet, and (ii) a ratchet tensioning device coupled to said strap and operable to tighten said strap around said fire sprinkler drain outlet when said fire sprinkler drain outlet is positioned within said proximal opening of said intake end portion of said conduit segment.

6. The conduit assembly of claim 5, further comprising a stabilizing component attached to said discharge end portion of said conduit assembly, said stabilizing component including (i) a first elongate portion extending from a first lateral side of said conduit segment, and (ii) a second elongate portion extending from a second lateral side of said conduit segment.

7. The conduit assembly of claim 5, wherein:
said discharge end portion defines a terminal end of said conduit segment, and
said at least one distal opening is spaced apart from said terminal end of said conduit segment.

8. The conduit assembly of claim 5, wherein said discharge end portion has a first distal opening defined in a first lateral side of said conduit segment and a second distal opening defined in a second lateral side of said conduit segment.

9. The conduit assembly of claim 8, wherein:
said discharge end portion defines a terminal end of said conduit segment, and
each of said first distal opening and said second distal opening is spaced apart from said terminal end of said conduit segment.

10. The conduit assembly of claim 5, wherein:
said intake end portion of said conduit assembly includes a plurality of slits defined therein,
said strap of said coupling mechanism is threaded through said plurality of slits.

11. The conduit assembly of claim 9, wherein:
said discharge end portion of said conduit assembly further has a third distal opening and a fourth distal opening defined therein,
said third distal opening is defined in said first lateral side of said conduit assembly,
said fourth distal opening is defined in said second lateral side of said conduit assembly, and
each of said third distal opening and said fourth distal opening is spaced apart from said terminal end of said conduit segment.

12. The conduit assembly of claim 8, wherein said first distal opening and said second distal opening are configured to be uniform in size.

13. A conduit assembly adapted to be used with a fire sprinkler drain outlet, comprising:
a conduit segment including (i) an intake end portion having a proximal opening configured to receive said fire sprinkler drain outlet therein, and (ii) a discharge end portion defining a terminal end of said conduit segment and having a first distal opening defined in a first lateral side of said conduit segment and a second distal opening defined in a second lateral side of said conduit segment, each of said first distal opening and said second distal opening being spaced apart from said terminal end of said conduit segment;
a coupling mechanism operable to secure said conduit segment to said fire sprinkler drain outlet; and
a stabilizing component attached to said discharge end portion of said conduit assembly, said stabilizing component including (i) a first elongate portion extending from said first lateral side of said conduit segment, and (ii) a second elongate portion extending from said second lateral side of said conduit segment.

14. The conduit assembly of claim 13, wherein said coupling mechanism includes (i) a strap configured to form a loop, and (ii) a tensioning device coupled to said strap and configured to reduce size of said loop during operation of said tensioning device.

15. The conduit assembly of claim 14, wherein said coupling device is supported on said intake end portion of said conduit segment.

16. The conduit assembly of claim 14, wherein:
said intake end portion of said conduit assembly includes a plurality of slits defined therein,
said strap of said coupling mechanism is threaded through said plurality of slits.

17. The conduit assembly of claim 13, wherein:
said discharge end portion of said conduit assembly further has a third distal opening and a fourth distal opening defined therein,
said third distal opening is defined in said first lateral side of said conduit assembly,
said fourth distal opening is defined in said second lateral side of said conduit assembly, and
each of said third distal opening and said fourth distal opening is spaced apart from said terminal end of said conduit segment.

18. The conduit assembly of claim 13, wherein said first distal opening and said second distal opening are configured to be uniform in size.

19. A conduit assembly adapted to be used with a fire sprinkler drain outlet, comprising:
a conduit segment including (i) an intake end portion having a proximal opening configured to receive said fire sprinkler drain outlet therein, and (ii) a discharge end portion having a first distal opening defined in a first lateral side of said conduit segment and a second distal opening defined in a second lateral side of said conduit segment; and
a coupling mechanism positioned in contact said intake end portion of said conduit segment, said coupling mechanism including (i) a strap configured to extend around said fire sprinkler drain outlet, and (ii) a ratchet tensioning device coupled to said strap and operable to tighten said strap around said fire sprinkler drain outlet when said fire sprinkler drain outlet is positioned within said proximal opening of said intake end portion of said conduit segment.

20. The conduit assembly of claim 19, further comprising a stabilizing component attached to said discharge end portion of said conduit assembly, said stabilizing component including (i) a first elongate portion extending from said first lateral side of said conduit segment, and (ii) a second elongate portion extending from said second lateral side of said conduit segment.

21. The conduit assembly of claim 19, wherein:
said intake end portion of said conduit assembly includes a plurality of slits defined therein,
said strap of said coupling mechanism is threaded through said plurality of slits.

22. The conduit assembly of claim 19, wherein:
said discharge end portion of said conduit assembly further has a third distal opening and a fourth distal opening defined therein,
said third distal opening is defined in said first lateral side of said conduit assembly, and
said fourth distal opening is defined in said second lateral side of said conduit assembly.

23. The conduit assembly of claim 19, wherein said first distal opening and said second distal opening are configured to be uniform in size.
